(19) United States
(12) Patent Application Publication
(10) Pub. No.: US 2024/0427375 A1
(43) Pub. Date: Dec. 26, 2024

(54) WIRE LOCK SYSTEM

(71) Applicant: Apple Inc., Cupertino, CA (US)

(72) Inventors: Killian J. Poore, San Jose, CA (US); Jason L. Slupeiks, Sunnyvale, CA (US); Jason C. Sauers, Sunnyvale, CA (US); Phil M. Hobson, Menlo Park, CA (US)

(21) Appl. No.: 18/510,500

(22) Filed: Nov. 15, 2023

Related U.S. Application Data
(60) Provisional application No. 63/510,274, filed on Jun. 26, 2023.

(51) Int. Cl. G06F 1/16

(52) U.S. Cl. CPC G06F 1/163

(57) ABSTRACT

A wearable apparatus includes a head-mountable display frame, a first mechanical stop, a cover glass, a second mechanical stop, and a cable. The head-mountable display frame includes a first interface portion defining a first channel. The first mechanical stop is defined by the head-mountable display frame. The cover glass is attachable to the head-mountable display frame and includes a second interface portion defining a second channel. The second mechanical stop is defined by the cover glass, and is positionable against the first mechanical stop when the first interface portion is mated to the second interface portion, and the first interface portion and the second interface portion define a lumen. The cable is disposed along at least a portion of the lumen.

### CROSS-REFERENCE TO RELATED APPLICATION(S)

This claims priority to U.S. Provisional Patent Application No. 63/510,274, filed 26 Jun. 2023, and entitled “Wire Lock System,” the entire disclosure of which is incorporated by reference in its entirety.

### FIELD

The described embodiments relate generally to electronic devices. More particularly, the present embodiments relate to attaching components of an electronic device.

### BACKGROUND

Electronic devices and systems, such as portable computers, tablets, mobile phones, wearable devices, and the like typically include a display mounted to a housing which encloses various electronic components, such as batteries, microcontrollers, processors, antennas, etc. Various components of electronic devices are typically secured to each other and/or various other components during assembly. For example, the display is typically fixed onto the housing or enclosure. Additionally, enclosures for electronic devices typically include two or more parts of the enclosure fixed together to enclose the internal electronic components. Some internal electronic components may need to be fixed onto an interior surface of the housing. It can be desirable, whether for upgrade or maintenance, to be able to disassemble these parts to access the internal electronic components.

### SUMMARY

In at least one example, a wearable apparatus includes a head-mountable display frame, a first mechanical stop, a cover glass, a second mechanical stop, and a cable. The head-mountable display frame includes a first interface portion defining a first channel. The first mechanical stop is defined by the head-mountable display frame, the cover glass including a second interface portion defining a second channel. The cover glass is attachable to the head-mountable display frame. The second mechanical stop is defined by the cover glass. The second mechanical stop is positional against the first mechanical stop when the first interface portion is mated to the second interface portion, and the first interface portion and the second interface portion defining a lumen. The cable is disposed along at least a portion of the lumen.

In one example, the first mechanical stop and the second mechanical stop are configured to inhibit lateral translation of the head-mountable display frame relative to the cover glass when mated.

In one example, the cable vertically constrains the head-mountable display frame and the cover glass together.

In one example, a segment of at least one of the cable or the lumen includes a tapered cross-section.

In one example, the cable includes a cable cross-section that differs from a lumen cross-section.

In one example, the cable includes a coating, the coating including at least one of an expandable material, a pliable material, or a galvanized material.

In one example, the cable is electrically conductive.

In one example, the cable includes a shape-memory material.

In one example, the cable is disposed along an entirety of the lumen.

In at least one example, an electronic device includes a first housing portion, a second housing portion, a display, a processor connected to the display, and a locking member. The first housing portion defines a first groove and the second housing portion defines a second groove. The second housing portion is laterally fixed relative to the first housing portion. The display can be attached to the first housing portion. The processor can be disposed between the first housing portion and the second housing portion. The locking member can be removably positioned in the first groove and the second groove.

In one example, the first groove and the second groove are defined by respective segments of the first housing portion and the second housing portion interspaced by non-grooved segments.

In one example, the locking member is sized to have an interference fit with the first groove and the second groove when inserted into the first groove and the second groove.

In one example, the first groove and the second groove are biased to be positionally offset.

In one example, the first housing portion defines an access to the locking member.

In one example, the locking member includes at least one of polytetrafluoroethylene, nylon, metal, plastic, elastomer, or a poly vinyl polymer.

In at least one example, a head-mountable device includes a first component defining a first channel, a second component defining a second channel, a third component defining a third channel and a second channel, a first pliable member, and a second pliable member. The third component can be positioned adjacent to both of the first component and the second component. The first pliable member can be disposed in the first channel and the third channel, and the second pliable member can be disposed in the second channel and the fourth channel.

In one example, the first component includes a chassis, the second component includes a cover, and the third component includes at least one of a housing portion or a trim portion.

In one example, the third component includes a first surface and a second surface. The first surface defining the third channel, and the second surface defining the fourth channel and being positioned opposite the first surface.

In one example, the third component is positioned between the first component and the second component.

In one example, at least one of the first channel, the second channel, the third channel, or the fourth channel includes an open-face channel.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates an electronic device with a first housing portion and a second housing portion, according to one example;

FIG. 2 illustrates an exploded view of an electronic device with a first housing portion and a second housing portion configured to be wire locked, according to one example;

FIG. 3A illustrates a cross-sectional view of an electronic device including a first component and a second component, according to one example;

FIG. 3B illustrates a cross-sectional view of the electronic device including the first component, the second component, and a cable, according to one example;

FIG. 4A illustrates a cross-sectional view of an electronic device including the first component and the second component under a force, F, according to one example;

FIG. 4B illustrates a cross-sectional view of the electronic device including the first component and the second component when the clamping force, F, is removed, according to one example;

FIG. 5 illustrates a head-mountable device including a first component, a second component, and a third component wire locked by a first pliable member and a second pliable member, according to one example;

FIG. 6 illustrates a cross-sectional view of an electronic device with a tunable interface, according to one example;

FIG. 7 illustrates a cross-sectional view of an electronic device in which a cross-section of a cable is different than a cross-section of the interface, according to one example;

FIG. 8 illustrates a cross-sectional view of an electronic device with a coated cable, according to one example;

FIG. 9 illustrates a cross-sectional view of an electronic device with an irregular interface, according to one example;

FIG. 10 illustrates a cross-sectional view of an electronic device with a cable including a stop, according to one example;

FIG. 11 illustrates a cross-sectional view of an electronic device with a tapered cable, according to one example;

FIG. 12 illustrates a cross-sectional view of an electronic device with a tapered interface, according to one example; and

FIG. 13 illustrates a cross-sectional view of an electronic device with an access to the cable, according to one example.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure generally relates to electronic devices. More particularly, the present disclosure relates to systems and methods for attaching or securing one component to another component. Electronic devices can have two three-dimensional (3D) surfaces (e.g., that are not substantially planar) which can be difficult to secure together via screws or adhesives. Screws can absorb valuable real estate in the electronic device, especially as the demand for smaller and more compact devices increases. Adhesives can degrade over time and in certain environments, such as in a hot car or under water. Additionally, adhesives typically do not allow for convenient detaching of the two 3D surfaces and/or convenient reattaching of the two 3D surfaces, for example, for repairs, maintenance, etc.

An electronic device can include a first component and a second component (such as a display, a housing portion, or the like). For example, an electronic device can include a first housing portion, a second housing portion, and a locking member. The second housing portion can be laterally fixed relative to the first housing portion. The first housing portion can have a first groove and the second housing can have a second groove. The locking member can be removably positioned in the first groove and the second groove to secure the first housing portion to the second housing portion. In at least one example, the electronic device can also include a display (or another component, such as a trim piece) attached to at least one of the first housing portion or the second housing portion. In at least one example, the electronic device can include a processor disposed between the first housing portion and the second housing portion.

Various examples described herein for wire locking 3D components are directed to systems and methods to securely couple two components of an electronic device while utilizing comparatively little real estate to conventional methods and while providing the option to allow for coupling and decoupling the two components. For example, secured components can include a respective groove or a slot which together form a channel when the two components are mated. The channel can run about a perimeter of the two components or (alternatively) around a partial perimeter, such as around discrete segments or sections of an electronic device. A cable or wire can be threaded through the channel to act as a locking mechanism to secure the two components together. In the event that there is a need to separate the two components, the cable can be simply pulled out of the channel, thus unlocking the two components. In the event that there is need to recouple the two components, the cable can be rethreaded through the channel. The two components can have a mechanism (e.g., one or more mechanical stops) for preventing relative motion laterally and the cable can be the locking mechanism for preventing relative motion vertically (e.g., transversally). Such components can include portions of the housing, a display, a battery, etc.

The examples described herein for wire locking of 3D components provide versatile systems for securing the two components. For example, more than two components can be secured using the wire-locking system. More than two components can be secured by a single cable and a single formed channel, or alternatively, more than two components can be secured by multiple cables and multiple channels. The cable can be designed for various coupling requirements. For example, the cable shape, material, internal structure, flexibility, elasticity, etc. can be tailored to the specific requirement. The tolerances of the channel cross-section and of the cable can be designed to provide a strong and secure coupling between the components while requiring relatively little force to install (e.g., to thread the cable into the loop).

In some examples, the wire locking mechanism of the present disclosure can be implemented for tamper monitoring. For example, in some implementations, respective grooves of mating components may align with a clamping force but remain misaligned (or otherwise biased against a cable disposed in a channel) without a clamping force. Thus, without a specific clamp designed for the electronic device, the locking cable may be un-withdrawable and remain in its locking position inside the channel despite a user's efforts to pull apart the secured components (or withdraw the locking cable).

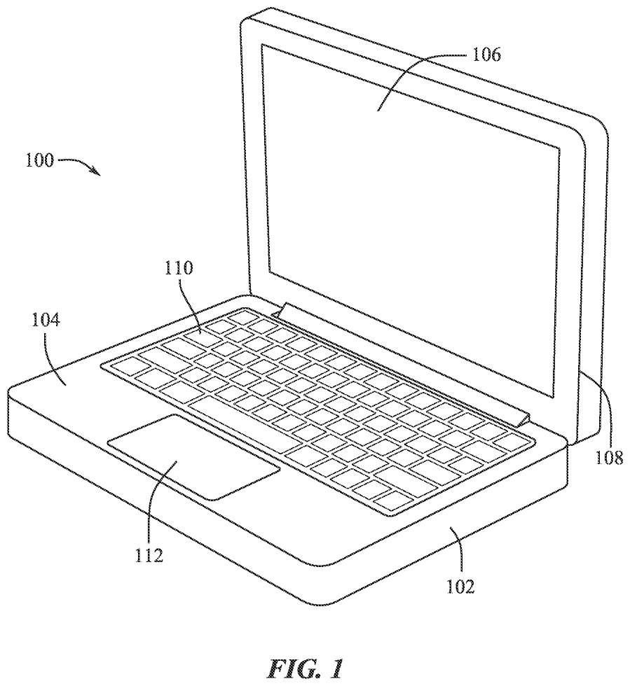

These and other embodiments are discussed below with reference to FIGS. 1-13. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates an electronic device 100 with a first housing portion 102 and a second housing portion 104, according to one example. The first housing portion 102 and the second housing portion 104 can be secured together via a wire locking element described further below in relation to subsequent figures. In at least one example, the electronic device 100 is a computing device or a portable computer. The electronic device 100 can include a display 106 and a display housing 108. The electronic device 100 can also include a keyboard 110 and a trackpad 112. These or other components of the electronic device 100 may be joined together via a wire locking element. For example, the display 106 may be joined to the display housing 108 via a wire locking element, as will be explained below.

Although not depicted in FIG. 1, the electronic device 100 can include processor(s), memory device(s), electronic storage device(s), portable power source(s) (e.g., batteries), power source connector(s), circuit boards, controller(s), and other related electronic components that can be housed within the first housing portion 102 and the second housing portion 104. For example, the electronic device 100 can include a controller unit connected to the display 106 for controlling the rendering of graphic representations. Additionally, the electronic device 100 can include a controller unit connected to the keyboard 110 and/or the trackpad 112 for receiving user inputs. In these or other examples, such a controller unit can include a processor, system on chip, integrated circuit, driver, microcontroller, application processor, crossover processor, etc. In certain examples, the controller unit can include one or more memory devices (e.g., individual nonvolatile memory, processor-embedded nonvolatile memory, random access memory, memory integrated circuits, DRAM chips, stacked memory modules, storage devices, memory partitions, etc.).

Although the electronic device 100 is depicted in FIG. 1 as being a laptop computer, the systems and methods of 3D wire locking described herein are applicable to a variety of different types of electronic devices, such as notebook computers, desktop computers, tablets, smart phones, and other portable electronic devices including smart watches, head-mountable devices, wearable devices, and the like. Thus, the electronic device 100 is shown merely as an example device with which aspects of the present disclosure are illustrated for convenience in providing an explanation and should not be viewed as limiting to a laptop computer.

For example, the electronic device 100 can be a wearable apparatus which can include a head-mountable display frame and a cover glass attachable to the head-mountable display frame. The head-mountable display frame can include a first interface portion defining a first channel. The cover glass can be attachable to the head-mountable display frame by the wire lock system described herein. The wearable apparatus can include a cable which is disposed along at least a portion of an interface between the head-mountable display frame and the cover glass to lock the head-mountable display frame to the cover glass.

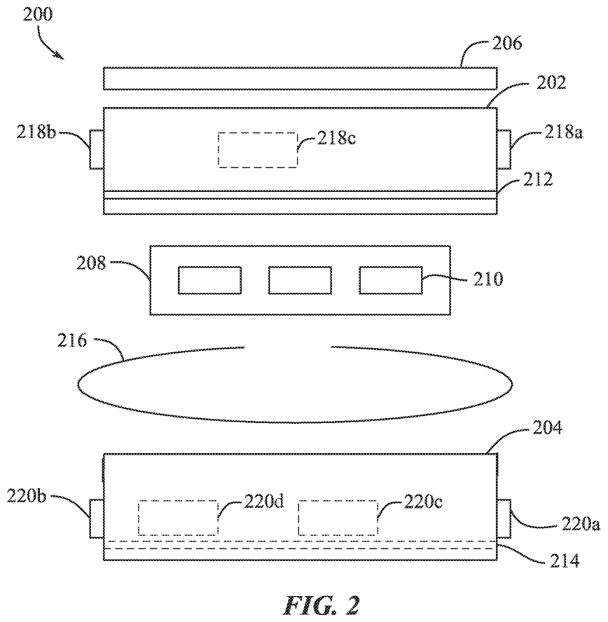

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1. Additional details of the device, including detailed cross-sectional views are detailed below with reference to FIG. 2.

FIG. 2 illustrates an exploded view of an electronic device 200 with a first housing portion 202 and a second housing portion 204 configured to be wire locked, according to one example. In at least one example, the electronic device 200 is a wearable apparatus, such as a head-mountable device or a smart watch. Thus, in some examples, at least one of the first housing portion 202 or the second housing portion 204 can correspond to a head-mountable display frame. A head-mountable display frame can include a shell, enclosure, housing, support structure, chassis, or body to which one or more other components may be attached. In these or other examples, however, the electronic device 200 can be a portable user device, such as a smart phone, a table, a laptop, or the like. Accordingly, in one case, the first housing portion 202 can be a frame of a body of the laptop and the second housing portion 204 can be a frame of a keyboard of the laptop. In another case, the first housing portion 202 can be a top shell of a smart phone and the second housing portion 204 can be a bottom shell of a smart phone.

In at least one example, the first housing portion 202 can be a frame located internally to the electronic device 200. The second housing portion 202 can be a frame configured to house an electronic component, such as a battery. The first housing portion 202 and the second housing portion 204 can be wire locked together.

The electronic device 200 can further include a display 206 attached to at least one of the first housing portion 202 or the second housing portion 204. In at least one example, the display 206 can include a screen, a cover (e.g., a shell, shield, or outer layer including glass or polymer) to externally cover and protect the screen, and/or various electronic components such as light-emitting diodes, controllers, etc., to define an image on the screen.

In addition, the electronic device 200 can include various internal electronic components 208 disposed between the first housing portion 202 and the second housing portion 204. In one example, the various internal electronic components 208 can include a processor 210. Additionally or alternatively, the various internal electronic components 208 can include a memory device.

As mentioned, the first housing portion 202 and the second housing portion 204 can mate together at an interface between the first housing portion 202 and the second housing portion 204. The term “interface” can include portions of the first housing portion 202 and the second housing portion 204 that are sized, shaped, and/or oriented to engage (e.g., contact, abut, mate with, be positioned adjacent to, etc.) one another. In certain implementations, an interface can include one or more features, such as a groove (i.e., grooves 212, 214), for aligning the first housing portion 202 and the second housing portion 204. A groove can include a slotted portion, channel, indentation, cored-out surface, etc. In specific implementations, a groove can include a semi-circular cutout in a surface of the first housing portion 202 and the second housing portion 204. As will be discussed below, a locking member 216 can be positioned inside the grooves 212, 214 when the first housing portion 202 and the second housing portion 204 are mated (e.g., within a clamp pushing the two housing portions against each other). The locking member 216 can vertically (or transversally) couple the first housing portion 202 and the second housing portion 204 when they are mated laterally. The locking member 216 can include a cable, a wire, a thread, or the like.

The electronic device 200 can further include a first mechanical stop 218a and a second mechanical stop 220a. The first and second mechanical stops 218a-b can be tabs, flanges, pins, tracks/rails, or the like. The first mechanical stop 218a can be defined by the first housing portion 202, and the second mechanical stop 220a can be defined by the second housing portion 204. The second mechanical stop 220a can be position-able against the first mechanical stop 218a (e.g., in intimate contact) when the second housing portion 204 and the first housing portion 202 are mated, such that the interface can define a lumen. The lumen can be a channel, tunnel, or other structural opening which can receiving the locking member 216 and allow the locking member 216 to be threaded through at least a portion. The second housing portion 204 can be laterally fixed relative to the first housing portion 202 by the first mechanical stop 218a and the second mechanical stop 220a. In particular, the first mechanical stop 218a and the second mechanical stop 220a can be configured to inhibit lateral translation of the first housing portion 202 and the second housing portion 204 relative to each other when the first housing portion 202 and the second portion 204 are mated.

In at least one example, the electronic device 200 can further include one or more mechanical stops 218b-c defined by (e.g., positioned on) the first housing portion 202 and one or more mechanical stops 220b-d defined by the second housing portion 204. The mechanical stops 218b-c and the mechanical stops 220b-c can be additionally or alternatively be configured to laterally fix the relative positions of the first housing portion 202 and the second housing portion 204 when they are mated. In other words, at least some of the mechanical stops 218a-c and the mechanical stops 220a-c can prevent the first housing portion 202 and the second housing portion 204 from laterally sliding relative to each other (e.g., left or right, or backwards and forwards out of the page). For instance, as depicted in FIG. 2, the mechanical stops 218c, 220c, and 220d are positionally offset relative to each other such that upon mating, the mechanical stop 218c is sandwiched between the mechanical stops 220c-220d. In so doing, lateral sliding in a left/right fashion is prevented for the first housing portion 202 and the second housing portion 204.

The mechanical stops 218a-c and the mechanical stops 220a-d can include a combination of clips, pins, tabs, sockets, grooves, tracks, rails, protrusions, ribs, convex dimples, interlocking members, or other appropriate mechanisms for preventing the first housing portion 202 from sliding along the second housing portion 204. In one example, the mechanical stops 218a-c and the mechanical stops 220a-d are tabs (e.g., interlocking tabs) that adjacently align or dovetail when the first housing portion 202 and the second housing portion 204 are mated. In one example, the mechanical stops 218a-c can be pins and the mechanical stops 220a-d can be sockets in which the pins can be fitted when the first housing portion 202 and the second housing portion 204 are mated.

The electronic device 200 can further include a locking member 216 for wire locking the first housing portion 202 and the second housing portion 204. The first housing portion 202 can include a first groove 212 and the second housing portion 204 can include a second groove 214. The locking member 216 can be removably positioned in the first groove 212 and the second groove 214. The locking member 216 can be a cable, such as a wire, thread, or the like disposed along at least a portion of the interface (e.g., lumen) between the head-mountable display frame and the cover glass. The locking member 216 can be a weed trimmer line, a fishing line, a tennis racket string, a multi-filament string, a metal cord, or other suitable cable. In at least one example, the cable can include nickel titanium (Nitinol), which exhibits shape memory and superelasticity. For example, a shape-memory material, such as Nitinol, can retain a given configuration (e.g., bent) at a first temperature and can assume its original configuration (e.g., straight, or less bent) at a second temperature (which can be greater than the first temperature). In at least one example, the cable can be electrically conductive to ground one or more components of the electronic device 200.

In at least one example, when the first housing portion 202 and the second housing portion 204 are mated, the first groove 212 and the second groove 214 can form a channel though which the locking member 216 can be threaded. The locking member 216 can be configured to prevent separation or decoupling of the first housing portion 202 and the second housing portion 204 once threaded into at least a portion of the channel. In other words, the locking member 216 can be configured to vertically constrain the first housing portion 202 and the second housing portion 204 when the first housing portion 202 and the second housing portion 204 are mated and the locking member 216 is at least partially disposed along an interface between the first housing portion 202 and the second housing portion 204. In at least one example, the locking member 216 includes an interference fit with the first groove 212 and the second groove 214 post-insertion of the locking member 216 into the first groove 212 and the second groove 214. For example, an interference fit occurs when a cross section of the locking member 216 and the first groove 212 and the second groove 214 are mismatched, biased away from each other, or the locking member 216 includes a greater size than the first and second grooves 212, 214.

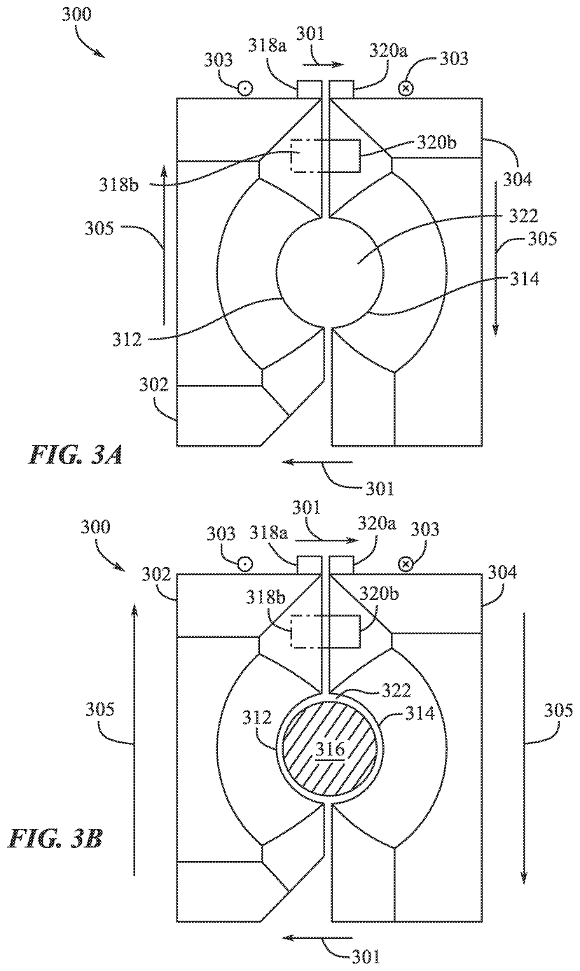

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2. Additional details of the device, including detailed cross-sectional views are detailed below with reference to FIGS. 3A and 3B.

FIG. 3A illustrates a cross-sectional view of an electronic device 300 including a first component 302 and a second component 304, according to one example. Although the components of the electronic device 300 may be arranged differently than the electronic device 200 and/or not all the components of the electronic device 200 may be depicted in FIG. 3, it should be noted that the components of the electronic device 300 may be the same as or similar to the components of the electronic device 200, as noted by similar reference numbers. For example, the first component 302 can correspond to the first housing portion 202, and the second component 304 can correspond to the second housing portion 204.

The electronic device 300 can be a head-mountable device, a smart watch, a mobile phone, a table, a laptop, a mouse, a keyboard, a monitor, a portable battery pack, or other electronic device including a first component and a second component which can be fixed together by wire locking.

The second component 304 can be attachable to the first component 302. In one example, the first component 302 can include a first groove 312, and the second component 304 can include a second groove 314. The first component 302 and the second component 304 can form an interface 322 when they are mated.

The first component 302 can include a mechanical stop 318a and a mechanical stop 318b. The second component 304 can include a mechanical stop 320a and a mechanical stop 320b. The mechanical stop 320a is positionable against the mechanical stop 318a. The mechanical stop 320b is positionable against the mechanical stop 318b. The mechanical stops 318a-b and 320a-b can be tabs, clips, pins/sockets, grooves/rails running along at least part of a perimeter of the electronic device 300, or other appropriate mechanical stop to prevent or inhibit lateral translation of the first component 302 and the second component 304 relative to each other when they are mated. In particular, the mechanical stop 318a and the mechanical stop 320a can be configured to inhibit lateral translation of the first component 302 and the second component 304 in a first lateral direction 301. The mechanical stop 318b and the mechanical stop 320b can be configured to inhibit lateral translation of the first component 302 and the second component 304 in a second lateral direction 303.

FIG. 3B illustrates a cross-sectional view of the electronic device 300 including the first component 302, the second component 304, and a cable 316, according to one example. The cable 316 can be disposed along at least a portion of the interface 322 between the first component 302 and the second component 304 when the first component 302 and the second component 304 are mated. The cable 316 can be configured to vertically constrain the first component 302 and the second component 304 together when the first component 302 and the second component 304 are mated. In particular, the cable 316 can be configured to inhibit translation of the first component 302 relative to the second component 304 in a vertical direction 305.

In one example, tolerances between the cable 316 and the interface 322 are such that a spacing/gap between the cable 316 and the interface 322 is between 0.05 millimeters (mm) and 0.2 mm when the cable 316 has a diameter between 0.5 mm and 1.5 mm, and a gap between the first component 302 and the second component is between 0.1 mm and 0.3 mm. In another example, the tolerances between the cable 316 and the interface 322 are such that the gap between the cable 316 and the interface 322 is between 0.02 millimeters (mm) and 0.5 mm when the cable 316 has a diameter between 0.5 mm and 1.5 mm, and a gap between the first component 302 and the second component 302 is between 0.05 mm and 0.5 mm. In other examples, the tolerances are such that the gap between the cable 316 and the interface 322, and the gap between the first component 302 and the second component 304 are such that a cable 316 can be threadable or otherwise inserted into the interface 322.

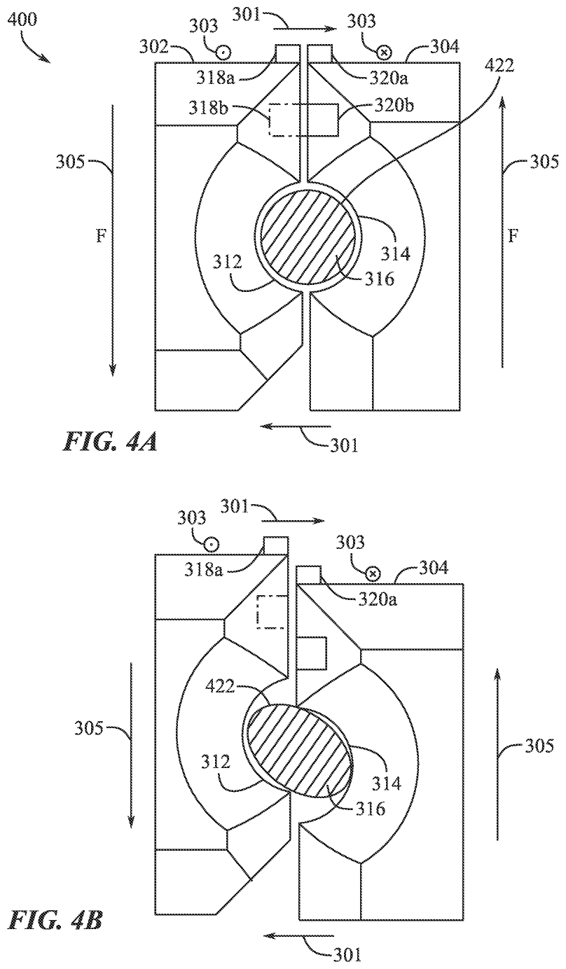

In one example, the cable 316 can be disposed along the interface 322 about an entirety of the interface between the first component 302 and the second component 304 (e.g., along an entire perimeter of the electronic device 300 (the perimeter running along the lateral direction 303)). In another example, the cable 316 can be disposed at least partially along the interface 322. For example, a first portion of the cable 316 can be disposed along a first portion of the interface. In some further examples, a second portion of the cable 316 can be disposed along a second portion of the interface 322 and/or a third portion of the cable 316 can be disposed along a second portion of the interface 322, etc. In at least one example, the cable 316 can be removably positioned in the first groove 312 and the second groove 314. In other words, the cable 316 can be removed from the entire interface 322 and/or the one or more portions of the interface 322. In particular, the cable 316 can be removed from the interface 322 without un-mating the first component 302 and the second component 304. In some cases, withdrawal of the cable 316 from the interface 322 may include application of a clamping force (as described more in conjunction with FIGS. 4A-4B).

It should be noted that depending on the shape of the perimeter of the electronic device 300, the lateral direction 303 is defined relative to a cross-section of the electronic device 300 at a given position. Similarly, the lateral direction 301 is defined relative to a cross-section of the electronic device 300 at the given position. Similarly, the vertical direction 305 is defined relative to a cross-section of the electronic device 300 at the given position. As such, in one example, the lateral directions 301 and 303 along with the vertical direction 305 can define a spatial basis based on three mutually perpendicular coordinate axes (e.g., x-, y-, and z-axes) at the given position. In other examples, the lateral directions 301 and 303 along with the vertical direction 305 do not need to be mutually perpendicular, but instead can be any three axes that define a Euclidean space.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3. Additional details of the device, including detailed cross-sectional views are detailed below with reference to FIG. 4A and FIG. 4B.

FIG. 4A illustrates a cross-sectional view of an electronic device 400 including the first component 302 and the second component 304 under a force, F, according to one example. Although the components of the electronic device 400 may be arranged differently than the electronic device 300 and/or not all the components of the electronic device 300 may be depicted in FIG. 4, it should be noted that the components of the electronic device 400 may be the same as or similar to the components of the electronic device 300, as noted by similar reference numbers.

In at least one example, the first groove 312 and the second groove 314 can be positionally aligned when the clamping force, F, is applied to the first component 302 and the second component 304. The clamping force can be mechanically applied (via a clamp, a vice grip, or other compression force) or can be applied as an ambient pressure or temperature, which can align the first groove 312 and the second groove 314. The first groove 312 and the second groove 314 can be positionally offset when the clamping force, F, is removed.

In at least one example, the first component 302 and the second component 304 can be configured to be offset along a vertical direction 305 when mated (e.g., as illustrated in FIG. 4B). In other words, the groove 312 and the groove 314 may be misaligned such that an interface 422 formed by the first groove 312 and the second groove 314 is distorted such that a cross-section of the interface 422 does not correspond to a cross-section of the cable 316. As such, the cable 316 may not be threadable between the first component 302 and the second component 304.

Upon application of a clamping force, F, in the vertical direction 305, the first groove 312 and the second groove 314 can be positionally aligned, such that the cross-section of the interface 422 can have substantially the same shape as the cross-section of the cable 316. Substantially the same can mean that the cable 316 is threadable between the first component 302 and the second component 304 such that the cable 316 is disposed along at least a portion of the interface 422. Additionally or alternatively, substantially the same can mean that in one example, tolerances between the cable 316 and the interface 422 are such that a spacing/gap between the cable 316 and the interface 422 is between 0.05 millimeters (mm) and 0.2 mm when the cable 316 has a diameter between 0.5 mm and 1.5 mm, and a gap between the first component 302 and the second component is between 0.1 mm and 0.3 mm. In another example, substantially the same can mean that tolerances between the cable 316 and the interface 422 are such that the gap between the cable 316 and the interface 422 is between 0.02 millimeters (mm) and 0.5 mm when the cable 316 has a diameter between 0.5 mm and 1.5 mm, and a gap between the first component 302 and the second component 302 is between 0.05 mm and 0.5 mm. In other examples, the tolerances are such that the gap between the cable 316 and the interface 422, and the gap between the first component 302 and the second component 304 are such that a cable 316 can be threadable into the interface 422.

FIG. 4B illustrates a cross-sectional view of the electronic device 400 including the first component 302 and the second component 304 when the clamping force, F, is removed, according to one example. When the clamping force, F, is removed, the groove 312 and the groove 314 can become misaligned, as described with respect to FIG. 4A. When the cable 316 is disposed within at least a portion of the interface 422, the cross-section of the cable 316 can become distorted by the misalignment of the groove 312 and the groove 314. In at least one example, the misalignment of the groove 312 and the groove 314 can exert a force on the cable 316 and can secure the cable 316 within the interface 422. Although the groove 312 and the groove 314 are misaligned such as to exert force on the cable, they can be still sufficiently laterally aligned to provident lateral translation of the second component 304 with respect to the first component 302. Additionally or alternatively, the cable 316 positioned along the interface 322 can act as a binder, thereby preventing the first housing portion 302 and the second housing portion 304 from shearing relative to each other in the direction 305

In at least one example, the clamping force, F, can be applied when the cable 316 is threaded into the interface 422 (e.g., during manufacturing). The clamping force, F, can be removed after the cable 316 is threaded into the interface (e.g., to wire lock the first component 302 and the second component 304 together). The clamping force, F, can be reapplied to remove the cable 316 from the interface 422 (e.g., to decouple the first component 302 from the second component 304).

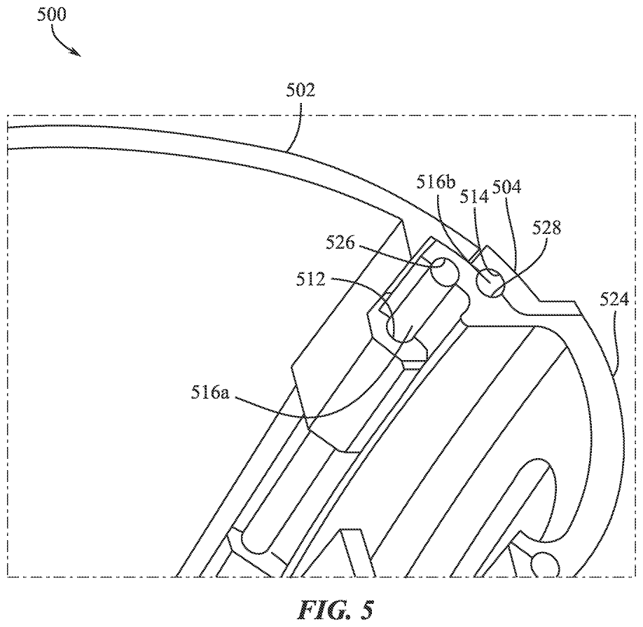

Any of the features, components, and/or parts, including the arrangements and configurations thereof shown in FIGS. 4A-B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 4A-B. Additional details of the device, including detailed cross-sectional views are detailed below with reference to FIG. 5.

FIG. 5 illustrates a head-mountable device 500 including a first component 502, a second component 504, and a third component 524 wire locked by a first pliable member 516a and a second pliable member 516b, according to one example. It should be noted that although the description of FIG. 5 refers to a head-mountable device, in other examples, the same or similar description can be applied to other electronic devices that include two or more components that can be wire locked. For example, the first component 502, the second component 504, and/or the third component 524 can be similar to any of the first housing portion 102 or the second housing portion 104 of FIG. 1; the first housing portion 202 or the second housing portion 204 of FIG. 2; or the first component 302 or the second component 304 of FIGS. 3-4. Similarly, the first pliable member 516a and the second pliable member 516b can be similar to the locking member 216 of FIG. 2 or the cable 316 of FIGS. 3-4.

In at least one example of the head-mountable device 500, the first component 502 can be a chassis (e.g., a structural framework that can define an outer structure of the head-mountable device 500.), the second component 504 can be a glass element to protect a screen and internal electronic display-related components of the head-mountable device 500, and the third component 504 can be at least one of a housing portion or a trim portion (e.g., a component which can provide enclosure, design, and structure to the head-mountable device 500).

In at least one example, the third component 524 can be positioned adjacent to both the first component 502 and the second component 504. The first component 502 defines a first channel 512, the second component 504 defines a second channel 514, and the third component 524 defines a third channel 526 and a fourth channel 528. In one example, a first interface portion defines the first channel 512, a second interface portion defines the second channel 514, a third interface portion defines the third channel 526, and a fourth interface portion defines the fourth channel 528. In at least one example, the first channel 512 can be a first groove, the second channel 514 can be a second groove, the third channel 526 can be a third groove, and the fourth channel 528 can be a fourth groove. The first pliable member 516a can be threaded through the first channel 512 and the third channel 526, which form a first interface when the first component 502 and the third component 524 are mated, to wire lock the first component 502 to the third component 524. The second pliable member 516b can be threaded through the second channel 514 and the fourth channel 528, which form a second interface when the second component 504 and the third component 524 are mated, to wire lock the second component 504 to the third component 524.

In at least one example, the third component 524 can be positioned between the first component 502 and the second component 504. The third component 524 can have a first surface defining the third channel 526. The third component 524 can also have a second surface defining the fourth channel 528. In one example, the second surface can be positioned opposite the first surface. For example, the third channel 526 can be a third groove which opens longitudinally in a first direction, and the fourth channel 528 can be a fourth groove which opens longitudinally in a second direction opposite the first direction. In another example, the third component 524 can be curved or bent and the second surface can be positioned at an obtuse angle with respect to the first surface.

In other examples, the first component 502 and the second component 504 can both be located on the same side of the third component 524. The first surface defining the third channel 526 and second surface defining the fourth channel 528 can both be defined by the same side of the third component 524. For example, the third channel 526 can be a third groove and the fourth channel 528 can be a fourth groove. The third groove and the fourth groove can open longitudinally on the same side of the third component 524.

In some examples, at least one of the first channel 512, the second channel 514, the third channel 526, or the fourth channel 528 includes an open-face channel. An open-face channel can have a half-circle cross-section (e.g., 180° of the channel is open) or a semi-circle cross-section (e.g., 5°, 10°, 30°, 60°, 90°, 120°, 270°, 320°, or other angle between 1º and 359º of the channel can be open). In some examples, at least one of the first channel 512, the second channel 514, the third channel 526, or the fourth channel 528 includes a closed-face channel (e.g., 0° of the channel is open). In this case, the close-faced channel does not need an opposing channel (e.g., the first channel 512 can oppose the third channel 526, while the second channel 514 can oppose the fourth channel 528) for a pliable member to be threaded.

In some examples, at least one of the first channel 512, the second channel 514, the third channel 526, or the fourth channel 528 can be segmented. In other words, along the perimeter of the head-mountable device 500, at least one of the first channel 512, the second channel 514, the third channel 526, or the fourth channel 526 can be open faced for some portions, be close faced for some portions, or be non-existent in some portions. For example, as depicted in FIG. 5, along the first pliable member 516a: 1) at a first portion, the first channel 512 is non-existent and the third channel 526 is open faced, 2) at a second portion, the first channel 512 and the third channel 526 are open faced, and the open faces of the first channel 512 and the third channel 526 face each other, and 3) at a third portion, the first channel 512 and the third channel 526 are open faced, and the open faces of the first channel 512 and the third channel 526 face each other in opposite directions as in the second portion. In other examples, at a particular portion, the first channel 512 is open faced and the third channel 526 is non-existent. In other examples, at a particular portion, the first channel 512 is open faced and the third channel is open faced. In at least one example, this case can correspond to a portion which is an access point through which the first pliable member 516a can be threaded into other portions of the first channel 512 and the third channel 526. Similar combinations of open-faced, closed-faced, and/or non-existent channels are also applicable to the second channel 514 and the fourth channel 528.

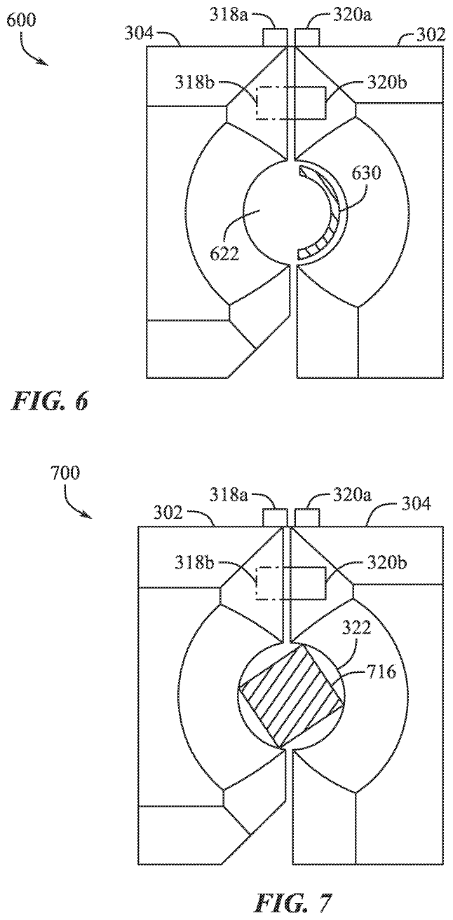

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5. Additional details of the device, including detailed cross-sectional views are detailed below with reference to FIG. 6.

FIG. 6 illustrates a cross-sectional view of an electronic device 600 with a tunable interface 622, according to one example. Although the components of the electronic device 600 may be arranged differently than the electronic device 300 and/or not all the components of the electronic device 300 may be depicted in FIG. 6, it should be noted that the components of the electronic device 600 may be the same as or similar to the components of the electronic device 300, as noted by similar reference numbers.

In at least one example, the interface 622 can include the first component 302, the second component 304, and a buffer 630. The buffer 630 can be added to at least one surface of the first groove 312 or the second groove 314 to bias the cable 316 towards the opposing groove, such that the cable 316 is not centered within the interface 622. For example, when the buffer 630 is added to the first groove 312, the cable 316 can be biased towards the second groove 314, while when the buffer 630 is added to the second groove 314, the cable 316 can be biased towards the first groove 312. In some examples, the cable 316 can be biased to reduce play of the cable 316 within the interface 622 and to absorb the tolerances between the cable 316 and the interface 622.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6. Additional details of the device, including detailed cross-sectional views are detailed below with reference to FIG. 7.

FIG. 7 illustrates a cross-sectional view of an electronic device 700 in which a cross-section of a cable 716 is different than a cross-section of the interface 322, according to one example. Although the components of the electronic device 700 may be arranged differently than the electronic device 300 and/or not all the components of the electronic device 300 may be depicted in FIG. 7, it should be noted that the components of the electronic device 700 may be the same as or similar to the components of the electronic device 300, as noted by similar reference numbers.

In at least one example, the cable 716 includes an interference fit with the interface 322 post-insertion of the cable into the first component 302 and the second component 304. For example, the cable 716 can have a cable cross-section that differs from an interface cross-section of the interface 322. Such a configuration can allow for one or more forces between the cable 716 and the interface 322, which can wedge the cable 716 within the interface 322. This can secure the cable 716 within the interface 322 and can reduce play of the cable 716 within the interface 322 and can absorb the tolerances between the cable 716 and the interface 322.

In at least one example, the cable 716 can have a non-circular cable cross-section while the interface 322 has a circular interface cross-section. As depicted in FIG. 7, the cable cross-section can be rectangular while the interface cross-section can be circular. In this case, corners of the rectangle can contact the surfaces of the interface 322, which can allow the cable 716 to be threaded into the interface 322 while providing a friction force to secure the cable 716 in place once the cable 716 has been threaded into the interface 322. Although not depicted in FIG. 7, in other examples, the cable can have other cross-sections, such as triangular, pentagonal, hexagonal, octagonal, star, etc., or an arbitrary shape. Additionally or alternatively, the cable 716 can have a non-uniform cross section along a length of the cable.

In at least one example, the cable 716 can have a circular cross-section while the interface 322 can have a non-circular cross-section. In this case, various points of the interface can contact the cable, which can allow the cable to be threaded into the interface while providing a friction force to secure the cable in place once it has been threaded into the interface. In some examples, the interface can have cross-sections, such as triangular, pentagonal, hexagonal, octagonal, star, etc., or an arbitrary shape.

In at least one example, both the cable 716 and the interface 322 can have non-circular cross-sections. Similar to the other examples, such configuration can allow the cable to be threaded into the interface while providing a friction force to secure the cable in place once it has been threaded into the interface. In some examples, at least one of the interface or the cable can have cross-sections, such as triangular, pentagonal, hexagonal, octagonal, star, etc., or an arbitrary shape.

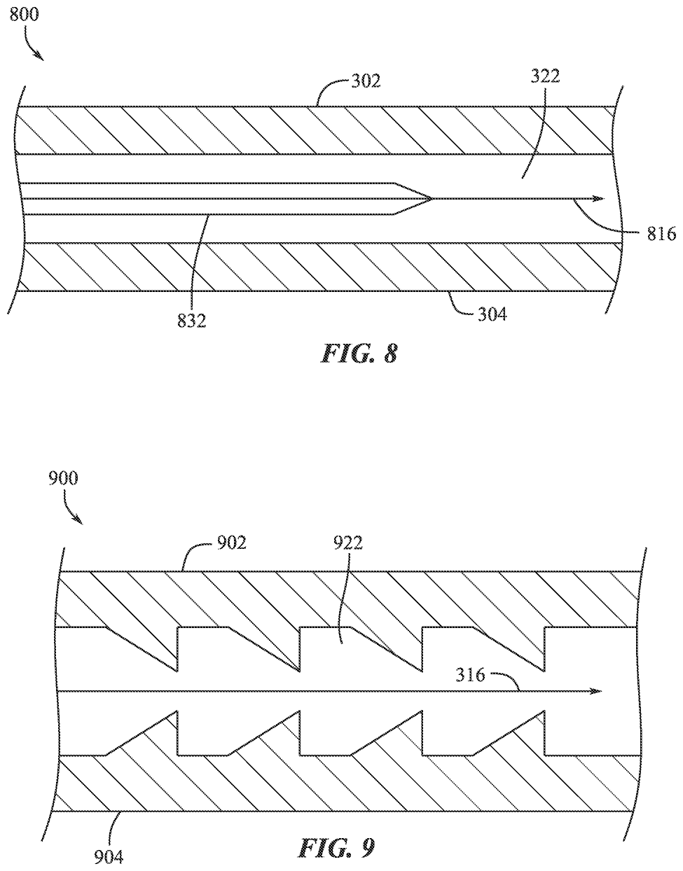

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7. Additional details of the device, including detailed cross-sectional views are detailed below with reference to FIG. 8.

FIG. 8 illustrates a cross-sectional view of an electronic device 800 with a coated cable 816, according to one example. It should be noted that in the follow description of FIGS. 8-13, although the components of the electronic devices 800-1300 may be arranged differently than the electronic device 300 and/or not all of the components of the electronic device 300 may be depicted in FIGS. 8-13, it should be noted that the components of the electronic devices 800-1300 may be the same as or similar to the components of the electronic device 300, as noted by similar reference numbers.

In at least one example, the cable 816 can include a coating 832. The coating can include at least one of an expandable material, a pliable material, or a galvanized material. In at least one example, the coating can include an elastic polymer (also referred to as an elastomer), such as a rubbery material composed of chain-like molecules, which are capable of recovering their original shape after being stretched or deformed. An elastic polymer can include natural rubbers, styrene-butadiene block copolymers, polyisoprene, polybutadiene, ethylene propylene rubber, ethylene propylene diene rubber, silicone elastomers, fluoroelastomers, polyurethane elastomers, nitrile rubbers, Pebax® elastomer, or the like. In at least one example, the cable 816 can include nickel titanium (Nitinol), which exhibits shape memory and superelasticity. In at least one example, the cable 816 can be electrically conductive to ground one or more components of the electronic device 800. In a case that the cable 816 is metallic, the cable 816 can be coated with a protective material (such as polytetrafluoroethylene (PTFE), nylon, or other appropriate material) to avoid galvanization or self-welding. Additionally or alternatively, the foregoing materials can be implemented in the cable 816 itself.

As depicted in FIG. 8, a first section of the cable 816 can have a first diameter (e.g., by being not coated or by being less coated by the coating 832), and a second section of the cable 816 can have a second diameter, less than the first diameter, due to the coating 832. In at least one example, in the second section of the cable 816, the coating 832 can be configured such that the second diameter is greater than a diameter of the interface 322 (e.g., when the cross-section of the interface is circular) (or greater than a minimum dimension of the interface 322, when the cross-section of the interface is non-circular), and the first diameter is less than the diameter of the interface. In this case, when the cable 816 is threaded into the interface 322, the coating 832 can deform to fit within the interface, and thus can absorb the tolerances and reduce play between the cable 816 and the interface 322. In at least one example, the cable 816 can be removable from the interface, and the coating 832 can assume its initial shape due to its elastic properties.

Any of the features, components, and/or parts, including the arrangements and configurations thereof shown in FIG. 8 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8. Additional details of the device, including detailed cross-sectional views are detailed below with reference to FIG. 9.

FIG. 9 illustrates a cross-sectional view of an electronic device 900 with an irregular interface 922, according to one example. The electronic device 900 can include a first component 902 and a second component 904. The first component 902 and the second component 904 can form the interface 922 when they are mated. In particular, the first component 902 can define a first channel 912 with a first surface, and the second component 904 can define a second channel 914 with a second surface. The first surface of the first channel 912 and the second surface of the second channel 914 can form the interface 922 when the first component 902 and the second component 904 are mated.

In some examples, at least one of the first channel 912 or the second channel 914 can have an irregular surface. The surface can include bumps, ridges, saw teeth, or other features that make the surface non-smooth. In some examples, the first channel 912 and/or the second channel 914 can have an irregular surface to reduce play of the cable 316 within the interface 922.

In at least one example, the first channel 912 and/or the second channel 914 can have a directionally irregular surface (e.g., a saw tooth pattern), which can allow the cable 316 to be threaded into the interface 922 along only one direction and not the opposite direction. Similarly, such a configuration can allow the cable 316 to be removed from (e.g., pulled out of) the interface in only one direction (the same direction that the cable 316 is threaded) and not the opposite direction.

As depicted in FIG. 9, the first surface of the first channel 912 and the second surface of the second channel 914 have a saw tooth pattern which allows the cable 316 to be threaded into the interface 922 in a first direction. Additionally, in some examples, the cable 316 can include a stop (e.g., a tab, pin, flange, or the like) that catches on the saw tooth pattern to prevent the cable 316 from being pulled out in a direction opposite to the direction of threading.

Any of the features, components, and/or parts, including the arrangements and configurations thereof shown in FIG. 9 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 9.

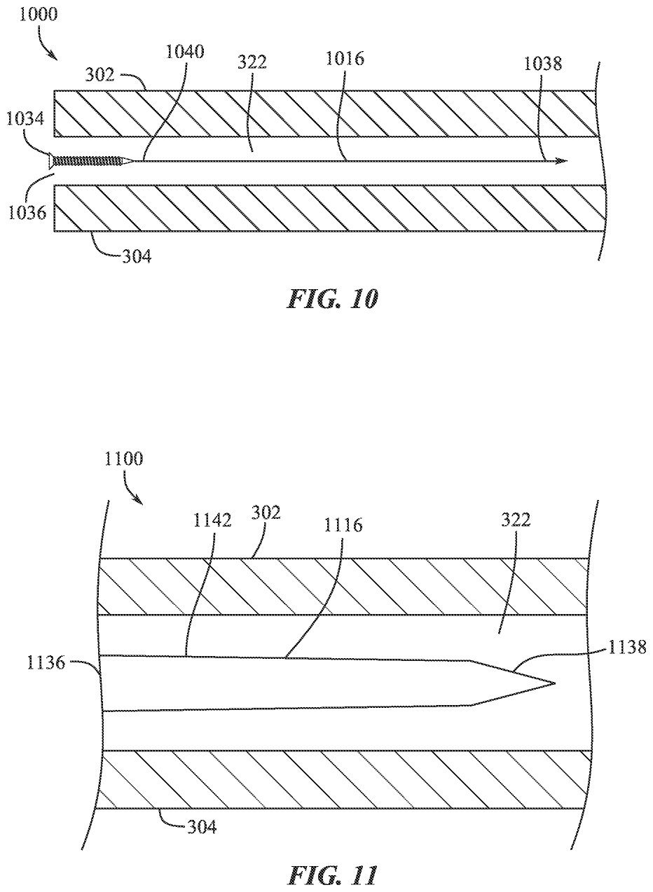

FIG. 10 illustrates a cross-sectional view of an electronic device 1000 with a cable 1016 including a stop 1034, according to one example. In at least one example, the cable 1016 can terminate in the stop 1034 at a second end 1040 of the cable 1016. A first end 1038 of the cable 1016 can be threaded into the interface 322 at an access point 1036. The access point 1036 can be an opening between the first component 302 and the second component 304 through which the first end 1038 of the cable 1016 can be inserted and the rest of the cable 1016 threaded. For example, the access point 1036 can be a portion along a perimeter of the electronic device 1000 at which the first component 302 and the second component 304 are non-existent to allow for the first end 1038 of the cable 1016 to be inserted. Additional details of the device, including detailed cross-sectional views are detailed below with reference to FIG. 10.

In at least one example, the cable 1016 can be threaded until it is disposed along at least a portion of the interface 322. The cable 1016 can be prevented from being further threaded by the stop 1034 at the second end 1040 of the cable 1016. In one example, the stop 1034 can be a part of the cable 1016 that can be received by the interface 322 at the access point 1036 to prevent the cable 1016 from being further threaded.

In one example, the stop 1034 can be a screw, as depicted in FIG. 10, which is attached to or part of the cable 1016. The access point 1036 can include a set of threads to receive the screw. In at least one example, a shape of a head of the screw can correspond to a cross-sectional shape of the access point 1036, such that the screw also functions as a cover of the access point 1036.

In one example, the stop 1034 can be a plug or a stopper which can be attached to or is part of the cable 1016, and which can be received by the access point 1036. The plug or stopper can have a shape which can correspond to the cross-sectional shape of the access point 1036 and can be frictionally mated to the access point 1036.

Any of the features, components, and/or parts, including the arrangements and configurations thereof shown in FIG. 10 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 10. Additional details of the device, including detailed cross-sectional views are detailed below with reference to FIG. 11.

FIG. 11 illustrates a cross-sectional view of an electronic device 1100 with a tapered cable 1116, according to one example. In at least one example, a diameter of the cable 1116 can be non-uniform along a length of the cable 1116. For example, as depicted in FIG. 11, a first end 1138 of the cable 1116, which is inserted into the interface 322, can have a smaller diameter than a diameter of a middle portion 1142 of the cable 1116. Tapering the first end 1138 can facilitate initially inserting the cable 1116 into the interface 322, especially with tighter tolerances between the interface 322 and the cable 1116. In one example, both ends of the cable 1160 can be tapered.

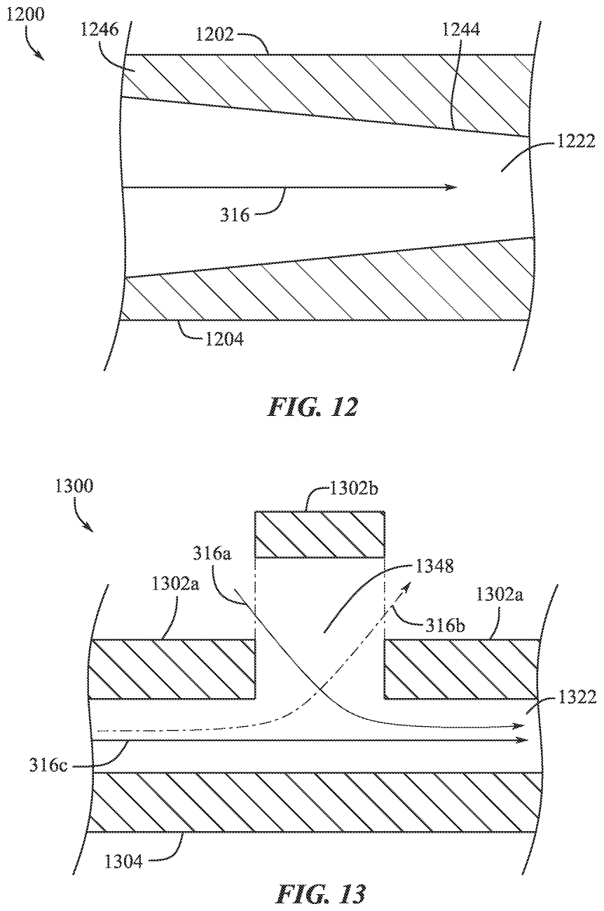

Any of the features, components, and/or parts, including the arrangements and configurations thereof shown in FIG. 11 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 11. Additional details of the device, including detailed cross-sectional views are detailed below with reference to FIG. 12.

FIG. 12 illustrates a cross-sectional view of an electronic device 1200 with a tapered interface 1222, according to one example. In at least one example, a diameter of the interface 1222 can be non-uniform along its length, such as along at least a portion of a perimeter of the electronic device 1200. For example, the electronic device 1200 includes a first component 1202 and a second component 1204. At least one of the first component 1202 or the second component 1204 can be tapered (e.g., have a non-zero pitch). The diameter of the interface can decrease along a direction of insertion of the cable 316, can increase along the direction of insertion of the cable 316, can remain constant along the direction of insertion of the cable 316, or can increase in some portions, decrease in some portions, and remain constant in some portions. In the example depicted in FIG. 12, a first portion 1244 of the interface 1222 can have a smaller diameter than a diameter of a second portion 1246 of the interface 1222. Varying the diameter of the interface 1222 can minimize or remove clearance between the first component 1202 and the second component 1204, while still allowing the cable 316 to be forced through the interface 1222 to wire lock the first component 1202 to the second component 1204.

In other implementations, the interface 1222 can have varied cross-sectional shapes, not just differing diameters (or tapered regions). For example, the interface 1222 can transition from a circular portion to a triangular portion, an oval portion, or a square portion (and vice-versa).

Any of the features, components, and/or parts, including the arrangements and configurations thereof shown in FIG. 12 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 12. Additional details of the device, including detailed cross-sectional views are detailed below with reference to FIG. 13.

FIG. 13 illustrates a cross-sectional view of an electronic device 1300 with an access 1348 to the cable 316, according to one example. Note that in FIG. 13, the labels 316a, 316b, and 316c refer to the same cable 316 in various configurations. Additionally, the labels 1302a and 1302b can refer to various portions of the first component 1302.

In at least one example, at least one of the first component 1302 or the second component 1304 define the access 1348 to the cable 316 for removing or inserting the cable 316. In some examples, the first component 1302 is a first housing portion, the second component 1304 is a second housing portion, and the cable 316 is a locking member of an electronic device, such as any of the electronic devices described herein.

The first component 1302 and the second component 1304 form an interface 1322 when the first component 1302 and the second component 1304 are mated. As depicted in FIG. 13, the second component 1304 can define a second channel. The first component 1302 includes a first portion 1302a that can generally define a first channel. In some further examples, the first component 1302 also includes a second portion 1302b. Although the second portion 1302b is not needed in every case, the second portion 1302b can serve as a cover to the access 1348, for example, to prevent a user from accessing the access 1348 and the cable 1316 or to protect internal electronics (processors, memory, microcontrollers, batteries, etc.) by preventing dust, debris, water, etc., from entering between the first component 1302 and the second component 1304. The second portion 1302b can be a removable panel, a hinged panel, a sliding panel or the like. The second portion 1302b can include one or more or a combination of screws, springs, hinges, tabs, adhesive, or the like. In some examples, the second portion 1302b can be a stop, such as the stop 1034 of FIG. 10.

In at least one example, the cable 316a can be inserted into the interface 1322 via the access 1348. In some further examples, the second portion 1302b can close the access 1348 when the cable 316a is threaded into the interface 1322. In at least one example, the cable 316b can be removed from the interface 1322 via the access 1348. In some further examples, the second portion 1302b can be removed to access the access 1348 to remove the cable 316a. In at least one example, the cable 316c can be disposed along at least a portion of the interface 1322 between the first component 1302 and the second component 1304. In some further examples, the second portion 1302b can be installed in the access 1348 to prevent access to the cable 316c. In some further examples, the second portion 1302b can be removed from the access 1348 to allow access to the cable 316c.

Any of the features, components, and/or parts, including the arrangements and configurations thereof shown in FIG. 13 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 13.

Some particular implementations of additional or alternative examples are as follows. In some examples, an electronic device can include or include/utilize some, all, none, or any combination of the clamping force, F, the buffer 630 of FIG. 6, mismatched cross-sections of the cable and/or the interface, the coating 832 of FIG. 8, the irregular interface 922 of FIG. 9, the stop 1034 of FIG. 10, the tapered cable 1116 of FIG. 11, the tapered interface 1222 of FIG. 12, or the access 1348 of FIG. 13. Wire locking can be additionally used to seal the electronic device from external conditions, such as water, dust, and debris.

In some examples, the cable (locking member) can include various internal structures. For example, the locking member can include a helically wound braid, such as a biaxial braid, such that when a force is applied along a length of the cable to stretch the cable, the cable lengthens and becomes narrower, while when the when the force is removed, the cable expands, thus absorbing tolerances between the cable and the interface. Additionally or alternatively, the cable can be inserted into the interface in an isolated and dry environment, and when the electronic device is moved to a more humid environment (e.g., with typical atmospheric conditions), the cable can expand and absorb tolerances. Additionally or alternatively, the cable can be inserted into the interface in a cold environment, and the able can expand at higher temperatures, such as room temperature. In some examples, the cable can be configured for providing information on tampering of the electronic device. For example, the cable can break, stretch, deform, etc. when a user attempts to remove the cable.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A wearable apparatus, comprising:
a head-mountable display frame including a first interface portion defining a first channel;
a first mechanical stop defined by the head-mountable display frame;
a cover glass attachable to the head-mountable display frame, the cover glass including a second interface portion defining a second channel;
a second mechanical stop defined by the cover glass, the second mechanical stop being positionable against the first mechanical stop when the first interface portion is mated to the second interface portion, the first interface portion and the second interface portion defining a lumen; and
a cable disposed along at least a portion of the lumen.

2. The wearable apparatus of claim 1, wherein the first mechanical stop and the second mechanical stop are configured to inhibit lateral translation of the head-mountable display frame relative to the cover glass when mated.

3. The wearable apparatus of claim 1, wherein the cable vertically constrains the head-mountable display frame relative to the cover glass.

4. The wearable apparatus of claim 1, wherein a segment of at least one of the cable or the lumen comprises a tapered cross-section.

5. The wearable apparatus of claim 1, wherein the cable comprises a cable cross-section that differs from a lumen cross-section.

6. The wearable apparatus of claim 1, wherein the cable comprises a coating including at least one of an expandable material, a pliable material, or a galvanized material.

7. The wearable apparatus of claim 1, wherein the cable is electrically conductive.

8. The wearable apparatus of claim 1, wherein the cable comprises a shape-memory material.

9. The wearable apparatus of claim 1, wherein the cable is disposed along an entirety of the lumen.

10. An electronic device, comprising:
a first housing portion defining a first groove;
a second housing portion defining a second groove, the second housing portion being laterally fixed relative to the first housing portion;
a display attached to the first housing portion;
a processor disposed between the first housing portion and the second housing portion; and
a locking member removably positioned in the first groove and the second groove.

11. The electronic device of claim 10, wherein the first groove and the second groove are interspaced by non-grooved segments defined by the first housing portion and the second housing portion.

12. The electronic device of claim 10, wherein the locking member is sized to have an interference fit with the first groove and the second groove when inserted into the first groove and the second groove.

13. The electronic device of claim 10, wherein the first groove and the second groove are biased to be positionally offset.

14. The electronic device of claim 10, wherein the first housing portion defines an access to the locking member.

15. The electronic device of claim 10, wherein the locking member comprises at least one of polytetrafluoroethylene, a nylon, a metal, a plastic, an elastomer, or a poly vinyl polymer.

16. A head-mountable device, comprising:
a first component defining a first channel;
a second component defining a second channel;
a third component defining a third channel and a fourth channel, the third component being positioned adjacent to both of the first component and the second component; and
a first pliable member disposed in the first channel and the third channel; and
a second pliable member disposed in the second channel and the fourth channel.

17. The head-mountable device of claim 16, wherein:
the first component comprises a chassis;
the second component comprises a cover; and
the third component comprises at least one of a housing portion or a trim portion.

18. The head-mountable device of claim 16, wherein the third component comprises:
a first surface defining the third channel; and
a second surface defining the fourth channel, the second surface being positioned opposite the first surface.

19. The head-mountable device of claim 16, wherein the third component is positioned between the first component and the second component.

20. The head-mountable device of claim 16, wherein at least one of the first channel, the second channel, the third channel, or the fourth channel includes an open-face channel.
